(19) United States
(12) Patent Application Publication
(10) Pub. No.: US 2026/0316651 A1
(43) Pub. Date: Oct. 15, 2026

(54) DUMP TRUCK

(71) Applicant: KOMATSU LTD., Tokyo (JP)

(72) Inventor: Shin NAKANO, Tokyo (JP)

(21) Appl. No.: 18/853,517

(22) PCT Filed: May 22, 2023
(86) PCT No.: PCT/JP2023/018886

§ 371 Date: Oct. 2, 2024

(30) Foreign Application Priority Data
May 31, 2022 (JP) 2022-089004

(51) Int. Cl. B60P 1/28; B60K 1/02; B60K 7/00; B60K 11/06; B60K 13/04; B60T 5/00; H02K 5/20; H02K 9/06; H02K 11/25; H02K 21/14

(52) U.S. Cl. CPC B60P 1/28; B60K 1/02; B60K 7/0007; B60K 11/06; B60T 5/00; H02K 5/207; H02K 9/06; H02K 11/25; H02K 21/14; B60K 13/04

(57) ABSTRACT

A dump truck includes a drive wheel, a vehicle body supported by the drive wheel, a dump body supported by the vehicle body, an electric motor that rotates the drive wheel, and a first duct through which air supplied from the electric motor to an internal flow path of the dump body flows.

### CROSS-REFERENCE TO RELATED APPLICATIONS

This application is a U.S. National stage application of International Application No. PCT/JP2023/018886, filed on May 22, 2023. This U.S. National stage application claims priority under 35 U.S.C. § 119(a) to Japanese Patent Application No. 2022-089004, filed in Japan on May 31, 2022, the entire contents of which are hereby incorporated herein by reference.

The present disclosure relates to a dump truck.

### BACKGROUND

A dump truck includes a dump body on which a load is loaded. When discharging the load from the dump body, the dump truck performs a dump operation of the dump body. When the dump operation is performed, the load is discharged from the dump body by the action of gravity. In a case where the load contains moisture or oil and is wet, and in a case where the outside air temperature is low, even when the dump operation is performed, a state in which at least a part of the load adheres to the inner surface of the dump body may be maintained, and the load may not be discharged from the dump body. A technique for heating a dump body in order to suppress adhesion of the load to the inner surface of the dump body is known. Currently, a technique of heating a dump body by exhaust of an engine is generally used. By heating the dump body, freezing of the load or curing of oil is suppressed, and the load is dried. Accordingly, adhesion of the load to the inner surface of the dump body is suppressed. JP 2012-201227 A discloses a dump truck including a resistor that converts electric power generated by a retarder brake operation into thermal energy, a cooling fan that cools the resistor, and a duct that guides warm air blown from the cooling fan and warmed by the resistor. In JP 2012-201227 A, warm air warmed by a resistor is supplied to a load bed (dump body) to heat the load bed.

### SUMMARY

When the engine is not mounted on the dump truck, the dump body cannot be heated by exhaust of the engine. In addition, in a case where the dump body is heated by the air warmed by the retarder brake (resistor), when the dump truck is traveling on an upward slope or a flat road, the retarder brake does not sufficiently generate heat, and thus it is difficult to supply high temperature air from the retarder brake to the dump body. As a result, there is a possibility that the dump body is not sufficiently heated.

An object of the present disclosure is to heat a dump body with air heated by an electric motor.

In order to achieve an aspect of the present disclosure, a dump truck comprises: a drive wheel, a vehicle body supported by the drive wheel, a dump body supported by the vehicle body, an electric motor that rotates the drive wheel, and a first duct through which air supplied from the electric motor to an internal flow path of the dump body flows.

According to the present disclosure, the dump body is heated by the air heated by the electric motor.

### BRIEF DESCRIPTION OF DRAWINGS

FIG. 1 is a side view illustrating a dump truck according to a first embodiment.

FIG. 2 is a schematic view of a dump truck according to the first embodiment as viewed from behind.

FIG. 3 is a side view illustrating a dump truck according to the first embodiment.

FIG. 4 is a view illustrating a dump body according to the first embodiment.

FIG. 5 is a side view illustrating the dump truck according to the first embodiment.

FIG. 6 is a view illustrating the dump body according to the first embodiment.

FIG. 7 is a schematic view of a dump truck according to a second embodiment as viewed from behind.

FIG. 8 is a schematic view of a dump truck according to a third embodiment as viewed from behind.

FIG. 9 is a side view illustrating a dump truck according to a fourth embodiment.

FIG. 10 is a side view illustrating a dump truck according to the fourth embodiment.

FIG. 11 is a view illustrating a dump body of a dump truck according to a fifth embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined. In addition, some components may not be used.

### First Embodiment

A first embodiment will be described.

### Dump Truck

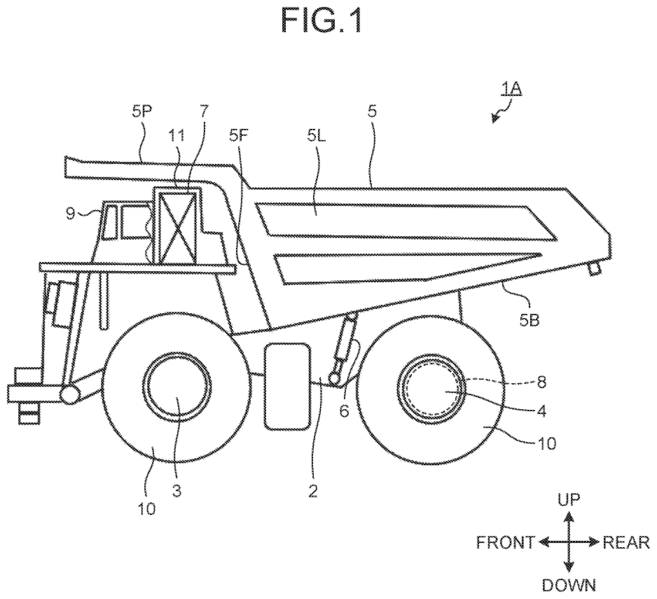

FIG. 1 is a side view illustrating a dump truck 1A according to the present embodiment. In the present embodiment, the dump truck 1A is a rigid frame type dump truck. The dump truck 1A is an electrically driven dump truck. No engine is mounted on the dump truck 1A. The dump truck 1A does not emit exhaust gas. The dump truck 1A includes a storage battery or a fuel cell as a power source. Note that the dump truck 1A may be driven by power supplied from a trolley wire.

As illustrated in FIG. 1, a dump truck 1A includes a vehicle body 2, front wheels 3, rear wheels 4, a dump body 5, a hoist cylinder 6, a retarder brake 7, and an electric motor 8.

The vehicle body 2 includes a chassis. The vehicle body 2 supports the dump body 5. A cab 9 is provided in an upper portion of a front portion of the vehicle body 2.

Each of the front wheels 3 and the rear wheels 4 supports the vehicle body 2. The front wheels 3 are steering wheels. The rear wheels 4 are drive wheels. A tire 10 is mounted on each of the front wheel 3 and the rear wheel 4. When each of the front wheels 3 and the rear wheels 4 rotates, the dump truck 1A travels.

The dump body 5 is loaded with a load. The load loaded on the dump body 5 is exemplified by earth and sand. The dump body 5 is rotatably supported by the vehicle body 2.

The hoist cylinder 6 generates power for rotating the dump body 5. The lower end portion of the hoist cylinder 6 is connected to the vehicle body 2. An upper end portion of the hoist cylinder 6 is connected to the dump body 5.

The dump body 5 changes to a loading posture and a standing posture by extension and contraction of the hoist cylinder 6. The loading posture refers to a posture lowered to be closest to the vehicle body 2 in a movable range of the dump body 5. The standing posture refers to a posture in which the dump body 5 is raised so as to be most separated from the vehicle body 2 in a movable range of the dump body 5. When the dump body 5 is in the loading posture, a load is loaded on the dump body 5. The dump truck 1A travels when the dump body 5 is in the loading posture. When the dump body 5 changes from the loading posture to the standing posture in a state where the load is loaded on the dump body 5, the load is discharged from the dump body 5 by the action of gravity. In the present embodiment, the operation of changing the dump body 5 from the loading posture to the standing posture in a state where the load is loaded on the dump body 5 is appropriately referred to as a dump operation.

When the dump operation of the dump body 5 is performed, the load is discharged from the dump body 5. In the present embodiment, the dump operation of the dump body 5 includes an operation of rotating the dump body 5 backward. That is, in the present embodiment, the dump body 5 discharges the load rearward by a rear dump method.

The retarder brake 7 is disposed behind the cab 9. The retarder brake 7 is accommodated in a brake housing 11.

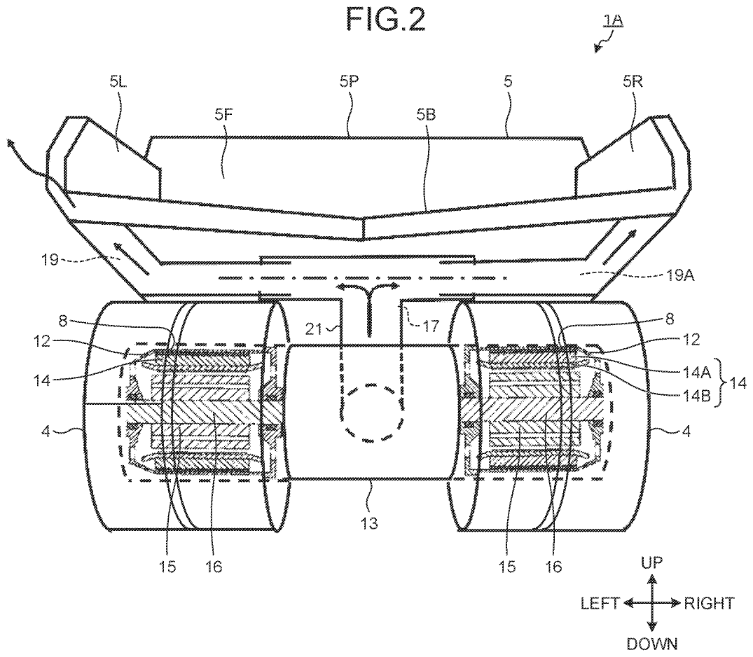

FIG. 2 is a schematic view of the dump truck 1A according to the embodiment as viewed from behind. The rear wheel 4 includes a first rear wheel 4 disposed on the left side (one side) of the center of the vehicle body 2 in a left-right direction (vehicle width direction) and a second rear wheel 4 disposed on the right side (the other side).

The electric motor 8 is connected to the rear wheel 4. The electric motor 8 rotates the rear wheels 4. A pair of electric motors 8 is provided. The pair of electric motors 8 is disposed in the left-right direction. The electric motor 8 includes a first electric motor 8 that rotates a left rear wheel 4 and a second electric motor 8 that rotates a right rear wheel 4. The left electric motor 8 is connected to the left rear wheel 4. The right electric motor 8 is connected to the right rear wheel 4.

The electric motor 8 is accommodated in a motor case 12. The electric motor 8 is accommodated in a motor housing 13 via the motor case 12. The electric motor 8 is disposed inside the motor housing 13 in a state of being accommodated in the motor case 12. The motor housing 13 is disposed between the left rear wheel 4 and the right rear wheel 4. The motor housing 13 functions as a rear axle case. The motor housing 13 has a substantially cylindrical shape. The motor housing 13 accommodates the left electric motor 8 and the right electric motor 8.

The electric motor 8 includes a stator 14, a rotor 15, and an output shaft 16. The stator 14 includes a stator core 14A and a coil 14B mounted on the stator core 14A. The stator 14 is fixed to the motor case 12. The rotor 15 is disposed inside the stator 14. The output shaft 16 is fixed to the rotor 15. The rotor 15 and the output shaft 16 rotate with respect to the stator 14. One end portion of the output shaft 16 on the outer side in the vehicle width direction is connected to the rear wheel 4.

### Dump Body

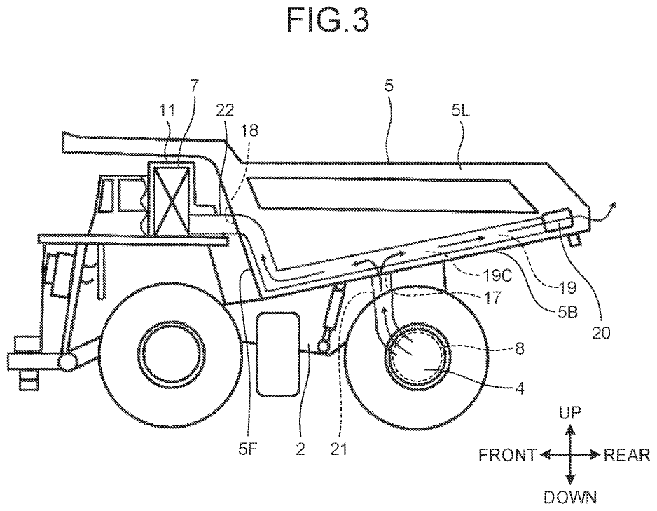

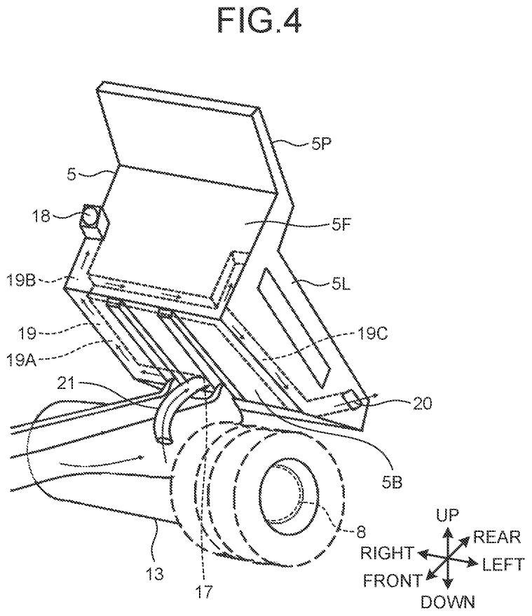

FIG. 3 is a side view illustrating the dump truck 1A according to the present embodiment. FIG. 4 is a diagram illustrating the dump body 5 according to the present embodiment.

The dump body 5 includes a front plate 5F, a bottom plate 5B connected to a lower end portion of the front plate 5F, a left plate 5L connected to a left end portion of the front plate 5F and a left end portion of the bottom plate 5B, a right plate 5R connected to a right end portion of the front plate 5F and a right end portion of the bottom plate 5B, and a protector plate 5P connected to an upper end portion of the front plate 5F.

The front plate 5F, the bottom plate 5B, the left plate 5L, the right plate 5R, and the protector plate 5P are integrated. Each of the front plate 5F, the bottom plate 5B, the left plate 5L, the right plate 5R, and the protector plate 5P is made of a steel material.

When the dump body 5 is in the loading posture, the protector plate 5P is disposed above the cab 9. The rear end portion of the protector plate 5P and the upper end portion of the front plate 5F are connected. The lower end portion of the front plate 5F and the front end portion of the bottom plate 5B are connected.

The right plate 5R is disposed on the right side of the center of the dump body 5 in the left-right direction, and is connected to each of the right end portion of the front plate 5F and the right end portion of the bottom plate 5B. The left plate 5L is disposed on the left side of the center of the dump body 5 in the left-right direction, and is connected to each of the left end portion of the front plate 5F and the left end portion of the bottom plate 5B.

In the dump body 5, a loading space in which the load is loaded is defined between a rear surface of the front plate 5F, an upper surface of the bottom plate 5B, a right surface of the left plate 5L, and a left surface of the right plate 5R. The load comes into contact with at least a part of the rear surface of the front plate 5F, the upper surface of the bottom plate 5B, the right surface of the left plate 5L, and the left surface of the right plate 5R. In the present embodiment, the rear surface of the front plate 5F, the upper surface of the bottom plate 5B, the right surface of the left plate 5L, and the left surface of the right plate 5R of the dump body 5 in contact with the load are appropriately collectively referred to as the inner surface of the dump body 5.

The dump body 5 includes a first inflow port 17 into which the air from the electric motor 8 flows, a second inflow port 18 into which the air from the retarder brake 7 flows, an internal flow path 19 through which the air flowing from at least one of the first inflow port 17 and the second inflow port 18 flows, and an outflow port 20 through which the air flowing through the internal flow path 19 is discharged.

The first inflow port 17 is provided on the lower surface of the bottom plate 5B. The first inflow port 17 is provided at a central portion of the bottom plate 5B in the left-right direction. The first inflow port 17 may be provided at a position shifted leftward or rightward from the central portion of the bottom plate 5B in the left-right direction. The first inflow port 17 is provided at the rear portion of the bottom plate 5B.

The second inflow port 18 is provided on the front surface of the front plate 5F. The second inflow port 18 is provided at the right portion of the upper portion of the front surface of the front plate 5F. The second inflow port 18 may be provided in the left portion of the upper portion of the front surface of the front plate 5F, or may be provided in the central portion.

The outflow port 20 is provided in the rear part of the left surface of the left plate 5L. The outflow port 20 may be provided in the right plate 5R.

The internal flow path 19 is provided inside the dump body 5. The internal flow path 19 includes a first flow path 19A provided at a boundary portion between the bottom plate 5B and the right plate 5R, a second flow path 19B provided at a boundary portion between the front plate 5F and the bottom plate 5B, and a third flow path 19C provided at a boundary portion between the bottom plate 5B and the left plate 5L. At least a part of the first flow path 19A is provided at the right end portion of the bottom plate 5B. At least a part of the second flow path 19B is provided at the lower end portion of the front plate 5F. At least a part of the third flow path 19C is provided at the lower end portion of the left plate 5L. The load easily adheres to the above-described boundary portion of the dump body 5. Therefore, the internal flow path 19 is provided at a boundary portion of the dump body 5. Note that the internal flow path 19 may be provided in a planar portion of the dump body 5.

The first flow path 19A, the second flow path 19B, and the third flow path 19C are connected to each other. The first inflow port 17 is connected to the first flow path 19A. The second inflow port 18 is connected to the second inflow port 18. The outflow port 20 is connected to the third flow path 19C.

### First Duct and Second Duct

The dump truck 1A includes a first duct 21 through which air supplied from the electric motor 8 to the internal flow path 19 of the dump body 5 flows. The first duct 21 is disposed so as to connect the motor housing 13 and the first inflow port 17 of the internal flow path 19. The lower end portion of the first duct 21 is connected to the central portion of the motor housing 13 in the left-right direction. The lower end portion of the first duct 21 may be connected to the left portion or the right portion of the motor housing 13. An upper end portion of the first duct 21 is connected to the first inflow port 17.

The dump truck 1A includes a second duct 22 through which air supplied from the retarder brake 7 to the internal flow path 19 of the dump body 5 flows. The second duct 22 is disposed so as to connect the brake housing 11 and the second inflow port 18 of the internal flow path 19. When the dump body 5 is in the loading posture, the second duct 22 and the second inflow port 18 are connected. When the dump body 5 is in the standing posture, the second duct 22 and the second inflow port 18 are cut.

### Air Flow

As indicated by arrows in FIGS. 3 and 4, the air around the electric motor 8 is supplied to the first inflow port 17 via the first duct 21. The air flowing into the internal flow path 19 of the dump body 5 from the first inflow port 17 flows through the internal flow path 19 and then is discharged from the outflow port 20. For example, when the dump truck 1A travels on an upward slope (uphill road) or a flat road, the electric motor 8 is driven, and as a result, the electric motor 8 generates heat. The air heated by the electric motor 8 is supplied to the internal flow path 19, whereby the dump body 5 is heated.

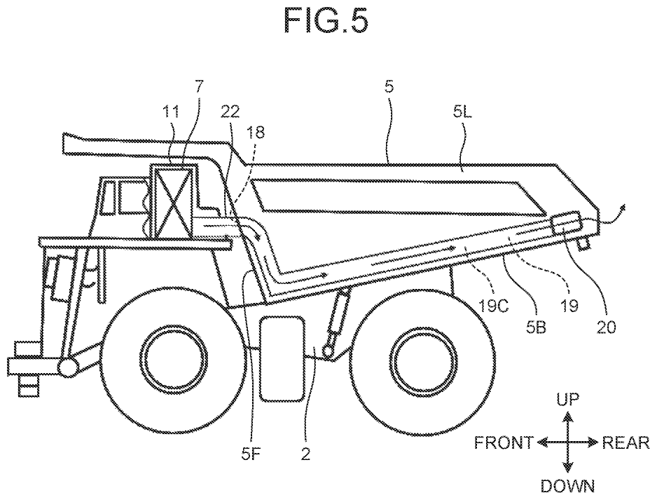

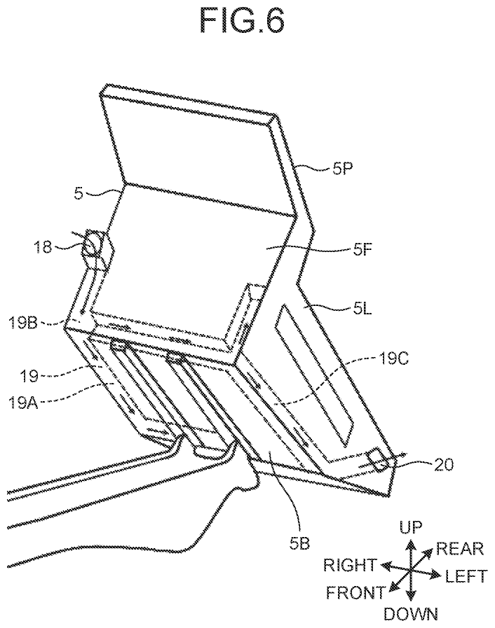

FIG. 5 is a side view illustrating the dump truck 1A according to the present embodiment. FIG. 6 is a diagram illustrating the dump body 5 according to the present embodiment. As indicated by arrows illustrated in FIGS. 5 and 6, the air around the retarder brake 7 is supplied to the second inflow port 18 via the second duct 22. The air flowing into the internal flow path 19 of the dump body 5 from the second inflow port 18 flows through the internal flow path 19 and then is discharged from the outflow port 20. For example, when the dump truck 1A travels on a downward slope (downhill road), the retarder brake 7 is operated, and as a result, the retarder brake 7 generates heat. The air heated by the retarder brake 7 is supplied to the internal flow path 19, whereby the dump body 5 is heated.

In the present embodiment, the supply of air from the electric motor 8 to the internal flow path 19 and the supply of air from the retarder brake 7 to the internal flow path 19 may be switched between when the dump truck 1A travels on an upward slope or a flat road and when the dump truck 1A travels on a downward slope. Air may be supplied from the electric motor 8 to the internal flow path 19 during traveling on an upward slope or a flat road, and air may be supplied from the retarder brake 7 to the internal flow path 19 during traveling on a downward slope. As a result, the dump body 5 is constantly heated during each of traveling on an upward slope, traveling on a flat road, and traveling on a downward slope.

When an in-vehicle controller of the dump truck 1A cannot determine whether the dump truck 1A is traveling on an upward slope, a flat road, or a downward slope, the in-vehicle controller may detect an operation state of each of the electric motor 8 and the retarder brake 7, and switch between supply of air from the electric motor 8 to the internal flow path 19 and supply of air from the retarder brake 7 to the internal flow path 19 based on the detected operation state. In addition, in a case where a first temperature sensor that detects the temperature around the electric motor 8 and a second temperature sensor that detects the temperature around the retarder brake 7 are provided, the in-vehicle controller may perform control such that the air is supplied from the electric motor 8 to the internal flow path 19 when a detection value of the first temperature sensor is equal to or more than a first predetermined value, and the air is supplied from the retarder brake 7 to the internal flow path 19 when a detection value of the second temperature sensor is equal to or more than a second predetermined value.

As described above, in the present embodiment, the dump truck 1A includes the rear wheels 4 which are drive wheels, the vehicle body 2 supported by the rear wheels 4, the dump body 5 supported by the vehicle body 2, the electric motor 8 that rotates the rear wheels 4, and the first duct 21 through which air supplied from the electric motor 8 to the internal flow path 19 of the dump body 5 flows. Since the air heated by the electric motor 8 is supplied to the internal flow path 19 of the dump body 5 via the first duct 21, the dump body 5 is heated. Therefore, the load is prevented from adhering to the inner surface of the dump body 5. In particular, when the dump truck 1A travels on an upward slope or a flat road, the amount of heat generated by the electric motor 8 increases, so that the dump body 5 is effectively heated.

The dump truck 1A includes the motor housing 13 that accommodates the electric motor 8. The first duct 21 is disposed so as to connect the motor housing 13 and the first inflow port 17 of the internal flow path 19. Since the electric motor 8 is accommodated in the motor housing 13, the air heated by the electric motor 8 is efficiently supplied to the internal flow path 19.

The motor housing 13 accommodates the left electric motor 8 and the right electric motor 8. The first duct 21 is connected to a central portion of the motor housing 13 in the left-right direction. As a result, each of the air heated by the left electric motor 8 and the air heated by the right electric motor 8 is efficiently supplied to the internal flow path 19.

The first inflow port 17 is provided in the bottom plate 5B of the dump body 5. This suppresses an increase in length of the first duct 21.

The dump truck 1A includes the retarder brake 7 and the second duct 22 through which air supplied from the retarder brake 7 to the internal flow path 19 of the dump body 5 flows. Since the air heated by the retarder brake 7 is supplied to the internal flow path 19 of the dump body 5 via the second duct 22, the dump body 5 is heated. Therefore, the load is prevented from adhering to the inner surface of the dump body 5. In particular, when the dump truck 1A travels on a downward slope, the amount of heat generated by the retarder brake 7 increases, so that the dump body 5 is effectively heated.

The dump truck 1A includes the brake housing 11 that accommodates the retarder brake 7. The second duct 22 is disposed so as to connect the brake housing 11 and the second inflow port 18 of the internal flow path 19. Since the retarder brake 7 is accommodated in the brake housing 11, the air heated by the retarder brake 7 is efficiently supplied to the internal flow path 19.

The second inflow port 18 is provided in the front plate 5F of the dump body 5. This suppresses an increase in length of the second duct 22.

### Second Embodiment

A second embodiment will be described. In the following description, the same or equivalent components as those of the above-described embodiment are denoted by the same reference numerals, and the description of the components is simplified or omitted.

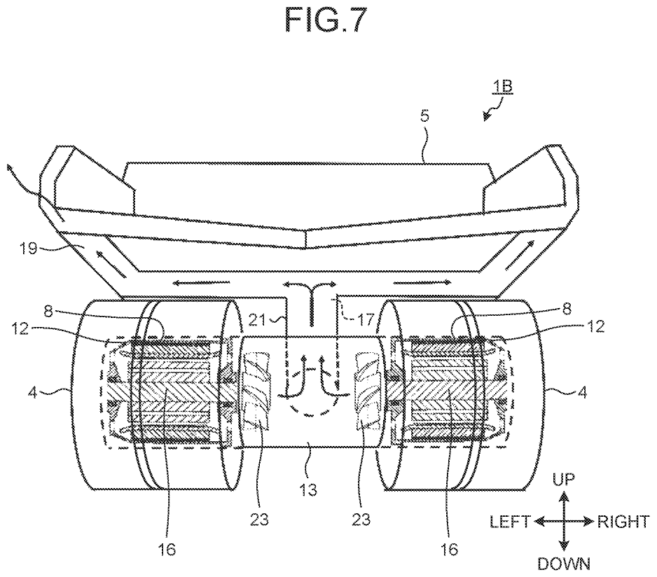

FIG. 7 is a schematic view of a dump truck 1B according to the present embodiment as viewed from the rear. As illustrated in FIG. 7, the dump truck 1B includes a blower fan 23 disposed inside the motor housing 13. The blower fan 23 rotates so that air is supplied from the electric motor 8 to the internal flow path 19 of the dump body 5. The blower fan 23 is rotated by the electric motor 8. In the present embodiment, the blower fan 23 is connected to the output shaft 16. When the output shaft 16 rotates, the blower fan 23 rotates.

The blower fan 23 is disposed at a position closer to the center of the motor housing 13 than the electric motor 8 in the left-right direction. That is, the blower fan 23 is disposed at a position closer to the first duct 21 than the electric motor 8. The blower fan 23 is connected to the other end portion of the output shaft 16 close to the center of the motor housing 13 in the left-right direction. As in the above-described embodiment, one end portion of the output shaft 16 is connected to the rear wheel 4.

The blower fan 23 is connected to each of the left electric motor 8 and the right electric motor 8. The blower fan 23 includes a first blower fan 23 rotated by the left electric motor 8 and a second blower fan 23 rotated by the right electric motor 8.

As described above, in the present embodiment, the dump truck 1B includes the blower fan 23 disposed inside the motor housing 13. The blower fan 23 rotates so that air is supplied from the electric motor 8 to the internal flow path 19 of the dump body 5. As a result, the air heated by the electric motor 8 is efficiently supplied to the internal flow path 19 via the first duct 21.

### Third Embodiment

A third embodiment will be described. In the following description, the same or equivalent components as those of the above-described embodiment are denoted by the same reference numerals, and the description of the components is simplified or omitted.

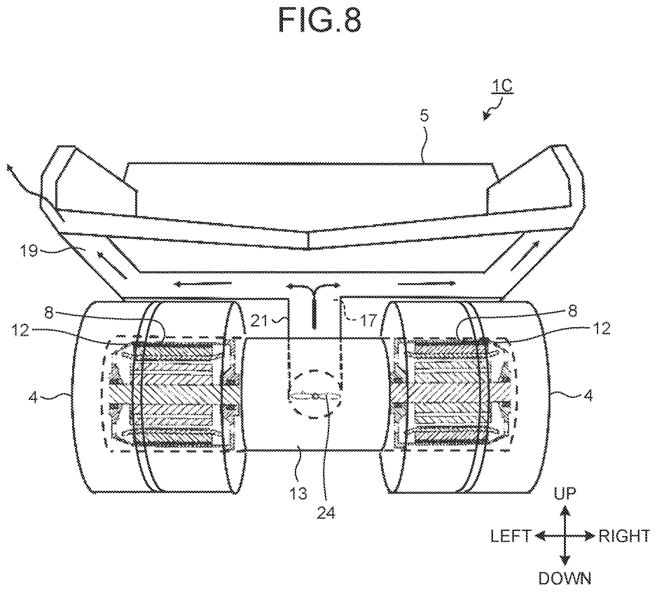

FIG. 8 is a schematic view of a dump truck 1C according to the present embodiment as viewed from the rear. As illustrated in FIG. 8, the dump truck 1C includes a blower fan 24 disposed inside the first duct 21. The blower fan 24 rotates so that air is supplied from the electric motor 8 to the internal flow path 19 of the dump body 5. The blower fan 24 is rotated by a motor (not illustrated) different from the electric motor 8.

The blower fan 24 rotates such that air is supplied from the electric motor 8 to the internal flow path 19 of the dump body 5 when the dump truck 1C travels on an upward slope or a flat road, and does not rotate when the dump truck 1C travels on a downward slope. This is because the electric motor 8 is driven and generates heat when the dump truck 1C travels on an upward slope or a flat road, but the electric motor 8 is not driven when the dump truck 1C travels on a downward slope. Note that the blower fan 24 may rotate when the temperature of the electric motor 8 is equal to or more than a first predetermined value determined in advance, and may not rotate when the temperature of the electric motor 8 is less than the first predetermined value. For example, when the first temperature sensor (not illustrated) that detects the temperature around the electric motor 8 is provided, the blower fan 24 may rotate when the detection value of the first temperature sensor is equal to or more than the first predetermined value, and may not rotate when the detection value of the first temperature sensor is less than the first predetermined value.

As described above, in the present embodiment, the dump truck 1C includes the blower fan 24 disposed inside the first duct 21. The blower fan 24 rotates so that air is supplied from the electric motor 8 to the internal flow path 19 of the dump body 5. As a result, the air heated by the electric motor 8 is efficiently supplied to the internal flow path 19 via the first duct 21.

Note that a retarder fan that rotates so that air is supplied from the retarder brake 7 to the internal flow path 19 of the dump body 5 may be provided. The retarder fan may be disposed inside the brake housing 11. The retarder fan may rotate such that air is supplied from the retarder brake 7 to the internal flow path 19 of the dump body 5 when the dump truck 1C travels on a downward slope, and may not rotate when the dump truck 1C travels on an upward slope or a flat road. This is because the retarder brake 7 operates to generate heat when the dump truck 1C travels on a downward slope, but the retarder brake 7 does not operate when the dump truck 1C travels on an upward slope or a flat road. The retarder fan may rotate when the temperature of the retarder brake 7 is equal to or more than a predetermined second predetermined value, and may not rotate when the temperature of the retarder brake 7 is less than the second predetermined value. For example, when a second temperature sensor (not illustrated) that detects the temperature around the retarder brake 7 is provided, the retarder fan may rotate when the detection value of the second temperature sensor is equal to or more than a second predetermined value, and may not rotate when the detection value of the second temperature sensor is less than the second predetermined value.

### Fourth Embodiment

a. A fourth embodiment will be described. In the following description, the same or equivalent components as those of the above-described embodiment are denoted by the same reference numerals, and the description of the components is simplified or omitted.

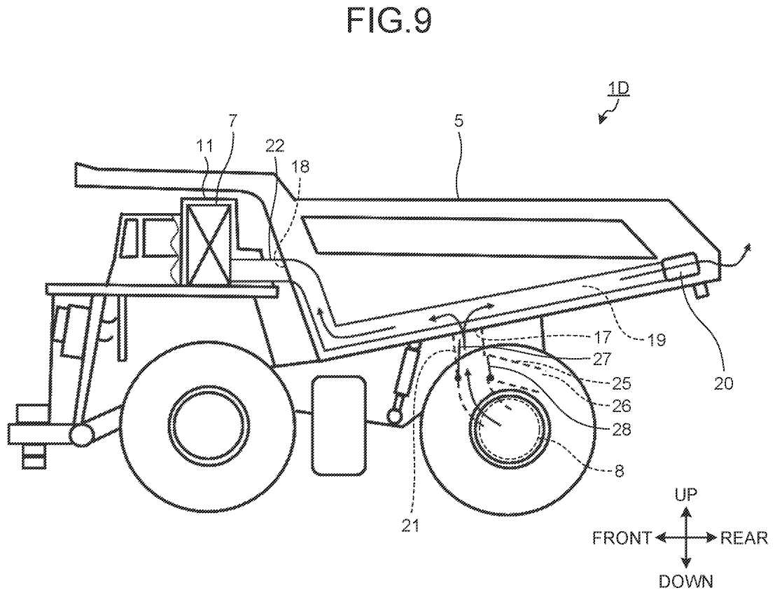

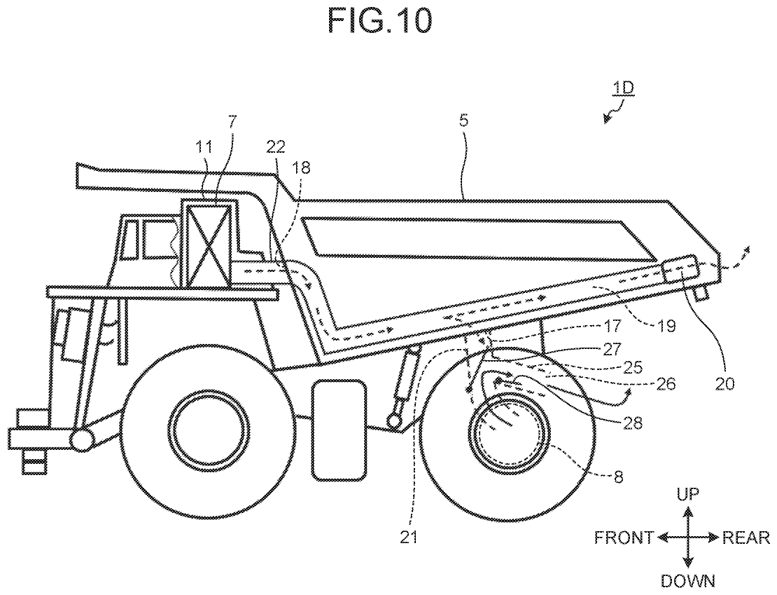

Each of FIGS. 9 and 10 is a side view illustrating a dump truck 1D according to the present embodiment. The dump truck 1D includes an exhaust duct 25 connected to the first duct 21, a first valve 27 that opens and closes a flow path of the first duct 21, and a second valve 28 that opens and closes a flow path of the exhaust duct 25. The exhaust duct 25 is arranged to branch off from the first valve 27 between the motor housing 13 and the first inflow port 17. One end portion of the exhaust duct 25 is connected to the first valve 27. An outflow port 26 is provided at the other end portion of the exhaust duct 25.

When the dump truck 1D travels on an upward slope or a flat road and when the dump truck 1D travels on a downward slope, the supply of air from the electric motor 8 to the internal flow path 19 and the supply of air from the retarder brake 7 to the internal flow path 19 are switched. Air is supplied from the electric motor 8 to the internal flow path 19 during traveling on an upward slope or a flat road, and air is supplied from the retarder brake 7 to the internal flow path 19 during traveling on a downward slope.

FIG. 9 illustrates states of the first valve 27 and the second valve 28 when the dump truck 1D travels on an upward slope or a flat road. As illustrated in FIG. 9, the first valve 27 opens the flow path of the first duct 21 during the dump truck travels on an upward slope or a flat road. The second valve 28 closes the flow path of the exhaust duct 25 during traveling on an upward slope or a flat road. The air supplied from the electric motor 8 to the internal flow path 19 is discharged from the outflow port 20. In this manner, air is supplied from the electric motor 8 to the internal flow path 19 during traveling on an upward slope or a flat road.

FIG. 10 illustrates states of the first valve 27 and the second valve 28 when the dump truck 1D travels on a downward slope. As illustrated in FIG. 10, the first valve 27 closes the flow path of the first duct 21 during traveling on a downward slope. The second valve 28 opens the flow path of the exhaust duct 25 during traveling on a downward slope. As a result, air is supplied from the retarder brake 7 to the internal flow path 19 during traveling on a downward slope. The air supplied from the retarder brake 7 to the internal flow path 19 is not supplied to the electric motor 8 but is discharged from the outflow port 20. In this manner, air is supplied from the retarder brake 7 to the internal flow path 19 during traveling on a downward slope. The air from the electric motor 8 is not supplied to the internal flow path 19 but is discharged to the periphery of the dump truck 1D via the exhaust duct 25.

As described above, in the present embodiment, the dump truck 1D includes the first valve 27 that opens and closes the flow path of the first duct 21. When the dump truck ID travels on an upward slope or a flat road, the flow path of the first duct 21 is opened, so that the air heated by the electric motor 8 is supplied to the internal flow path 19. When the dump truck 1D travels on a downward slope, the flow path of the first duct 21 is closed, so that the air heated by the retarder brake 7 is supplied to the internal flow path 19. As a result, the dump body 5 is constantly heated during each of traveling on an upward slope, traveling on a flat road, and traveling on a downward slope.

The dump truck 1D includes an exhaust duct 25 branching from the first duct 21, and a second valve 28 that opens and closes a flow path of the exhaust duct 25. When the flow path of the first duct 21 is opened while the dump truck 1D travels on an upward slope or a flat road, the flow path of the exhaust duct 25 is closed. As a result, the air heated by the electric motor 8 is efficiently supplied to the internal flow path 19. When the flow path of the first duct 21 is closed during traveling of the dump truck 1D on a downward slope, the flow path of the exhaust duct 25 is opened. As a result, the air from the electric motor 8 is discharged to the periphery of the dump truck 1D via the exhaust duct 25.

In the present embodiment, when the dump truck 1D travels on a downward slope, the electric motor 8 does not operate, and the blower fan 23 and the blower fan 24 also do not operate. That is, when the dump truck 1D travels on a downward slope, air is not supplied from the electric motor 8 to the internal flow path 19 of the dump body 5. Therefore, the exhaust duct 25 may be omitted.

### Fifth Embodiment

A fifth embodiment will be described. In the following description, the same or equivalent components as those of the above-described embodiment are denoted by the same reference numerals, and the description of the components is simplified or omitted.

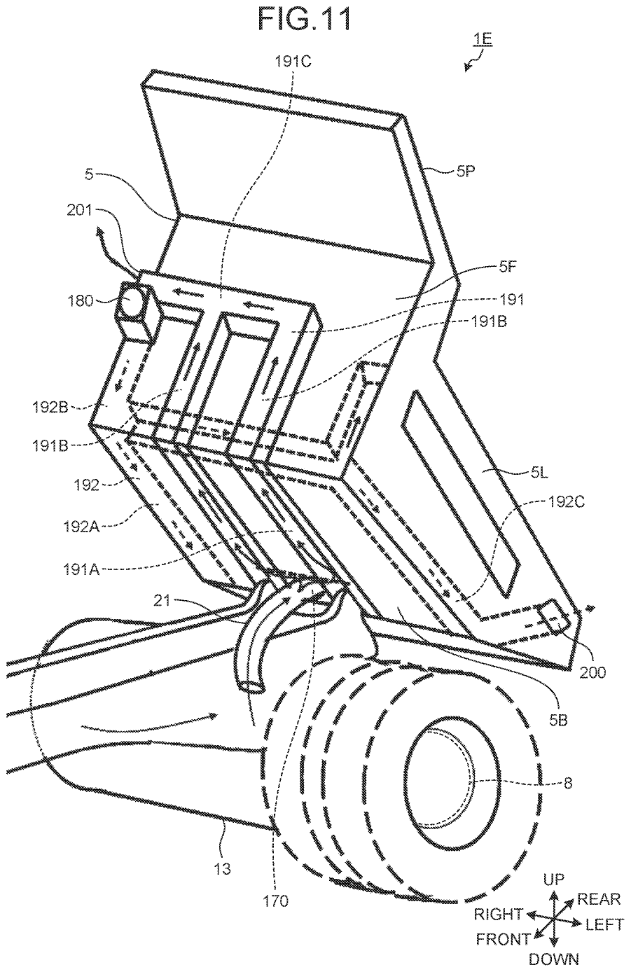

FIG. 11 is a diagram illustrating a dump body 5 of a dump truck 1E according to the present embodiment. Similarly to the above-described embodiment, the dump body 5 includes a bottom plate 5B, a left plate 5L, a right plate 5R, a front plate 5F, and a protector plate 5P.

In the present embodiment, the internal flow path of the dump body 5 includes a first internal flow path 191 and a second internal flow path 192 partitioned from the first internal flow path 191. The first internal flow path 191 and the second internal flow path 192 do not intersect. The first internal flow path 191 and the second internal flow path 192 are separate internal flow paths. The air flowing through the first internal flow path 191 is not supplied to the second internal flow path 192. The air flowing through the second internal flow path 192 is not supplied to the first internal flow path 191.

The first duct 21 is connected to a first inflow port 170 of the first internal flow path 191. Air from the electric motor 8 is supplied to the first inflow port 170 via the first duct 21. The air flowing into the first inflow port 170 flows through the first internal flow path 191 and then is discharged from an outflow port 201 of the first internal flow path 191. The first inflow port 170 is provided in a central portion of the lower surface of the bottom plate 5B in the left-right direction. The first inflow port 170 is provided at the rear portion of the bottom plate 5B. The outflow port 201 is provided at the front portion of the right surface of the right plate 5R.

The second duct 22 is connected to a second inflow port 180 of the second internal flow path 192. The air from the retarder brake 7 is supplied to the second inflow port 180 via the second duct 22. The air flowing into the second inflow port 180 flows through the second internal flow path 192 and then is discharged from an outflow port 200 of the second internal flow path 192. The second inflow port 180 is provided on the front surface of the front plate 5F. The second inflow port 180 is provided at the right portion of the upper portion of the front surface of the front plate 5F. The outflow port 200 is provided in the rear portion of the left surface of the left plate 5L.

At least a part of the first internal flow path 191 is provided at a central portion of the bottom plate 5B in the left-right direction (vehicle width direction). The second internal flow path 192 is provided at each of a boundary portion between the bottom plate 5B and the front plate 5F, a boundary portion between the bottom plate 5B and the left plate 5L, and a boundary portion between the bottom plate 5B and the right plate 5R.

In the present embodiment, the first internal flow path 191 includes a first flow path 191A provided inside the bottom plate 5B, and a second flow path 191B and a third flow path 191C provided inside the front plate 5F. The first flow path 191A is provided at a central portion of the bottom plate 5B in the left-right direction. In the present embodiment, the first flow path 191A is provided so as to extend in the front-rear direction. Two first flow paths 191A are provided at intervals in the left-right direction. The second flow path 191B is provided at the central portion of the front plate 5F in the left-right direction. In the present embodiment, the second flow path 191B is provided so as to extend in the vertical direction. Two second flow paths 191B are provided at intervals in the left-right direction. The front end portion of the first flow path 191A on the left side and the lower end portion of the second flow path 191B on the left side are connected. The front end portion of the first flow path 191A on the right side and the lower end portion of the second flow path 191B on the right side are connected. The third flow path 191C is provided so as to extend in the left-right direction. Each of the upper end portion of the second flow path 191B on the left side and the upper end portion of the second flow path 191B on the right side is connected to the third flow path 191C. The right end portion of the third flow path 191C is connected to the outflow port 201. The air from the first inflow port 170 flows into each of the rear end portion of the first flow path 191A on the left side and the rear end portion of the first flow path 191A on the right side. The air flowing into the first flow path 191A flows through the first flow path 191A, the second flow path 191B, and the third flow path 191C, and then is discharged from the outflow port 201.

In the present embodiment, the second internal flow path 192 includes a fourth flow path 192B provided inside the front plate 5F, a fifth flow path 192A provided inside the right plate 5R, and a sixth flow path 192C provided inside the left plate 5L. The fourth flow path 192B is connected to the second inflow port 180. At least a part of the fourth flow path 192B is provided at the lower end portion of the front plate 5F. At least a part of the fourth flow path 192B is provided at a boundary portion between the bottom plate 5B and the front plate 5F. At least a part of the fifth flow path 192A is provided at the lower end portion of the right plate 5R. At least a part of the fifth flow path 192A is provided at a boundary portion between the bottom plate 5B and the right plate 5R. At least a part of the sixth flow path 192C is provided at the lower end portion of the left plate 5L. At least a part of the sixth flow path 192C is provided at a boundary portion between the bottom plate 5B and the left plate 5L. The fourth flow path 192B, the fifth flow path 192A, and the sixth flow path 192C are connected to each other. The air flowing into the fourth flow path 192B from the second inflow port 180 flows through each of the fifth flow path 192A and the sixth flow path 192C, and then is discharged from the outflow port 201.

As described above, in the present embodiment, the air from the electric motor 8 flows through the first internal flow path 191, and the air from the retarder brake 7 flows through the second internal flow path 192 different from the first internal flow path 191. As a result, the dump body 5 is effectively heated by the air flowing through the first internal flow path 191 when the dump truck 1E travels on an upward slope or a flat road, and the dump body 5 is effectively heated by the air flowing through the second internal flow path 192 when the dump truck 1E travels on a downward slope. In addition, since the first internal flow path 191 and the second internal flow path 192 are partitioned, the air from the electric motor 8 is suppressed from being supplied to the retarder brake 7, and the air from the retarder brake 7 is suppressed from being supplied to the electric motor 8.

In the present embodiment, at least a part of the second internal flow path 192 is provided at each of a boundary portion between the bottom plate 5B and the front plate 5F, a boundary portion between the bottom plate 5B and the left plate 5L, and a boundary portion between the bottom plate 5B and the right plate 5R. On the inner surface of the dump body 5, the load easily adheres to a boundary portion (corner portion) between the upper surface of the bottom plate 5B and the rear surface of the front plate 5F, a boundary portion (corner portion) between the upper surface of the bottom plate 5B and the right surface of the left plate 5L, and a boundary portion (corner portion) between the upper surface of the bottom plate 5B and the left surface of the right plate 5R. In addition, the air from the retarder brake 7 is likely to have a higher temperature than the air from the electric motor 8. Since the high temperature air is supplied to each of the boundary portion between the bottom plate 5B and the front plate 5F, the boundary portion between the bottom plate 5B and the left plate 5L, and the boundary portion between the bottom plate 5B and the right plate 5R, adhesion of the load to the inner surface of the dump body 5 is effectively suppressed.

### Other Embodiments

In the embodiments described above, the rear wheels 4 are drive wheels. The front wheel 3 may be a drive wheel, and each of the front wheel 3 and the rear wheel 4 may be a drive wheel. The rear wheels 4 may be steered.

In the above-described embodiments, the dump truck (1A or the like) is a rigid frame type. The dump truck (1A or the like) may be an articulated type.

In the above-described embodiments, the dump truck (1A or the like) is the rear dump type. The dump truck (1A or the like) may be a side dump type in which a load is discharged from the dump body 5 by inclining the dump body 5 leftward or rightward.

1. A dump truck comprising:
a drive wheel;
a vehicle body supported by the drive wheel;
a dump body supported by the vehicle body;
an electric motor that rotates the drive wheel; and
a first duct through which air supplied from the electric motor to an internal flow path of the dump body flows.

2. The dump truck according to claim 1, further comprising
a motor housing that accommodates the electric motor,
the first duct being disposed so as to connect the motor housing and a first inflow port of the internal flow path.

3. The dump truck according to claim 2, wherein
the drive wheel includes a first drive wheel disposed on one side of a center of the vehicle body in a vehicle width direction and a second drive wheel disposed on the other side,
the electric motor includes a first electric motor that rotates the first drive wheel and a second electric motor that rotates the second drive wheel,
the motor housing accommodates the first electric motor and the second electric motor, and
the first duct is connected to a central portion of the motor housing in the vehicle width direction.

4. The dump truck according to claim 2, wherein
the first inflow port is provided in a bottom plate of the dump body.

5. The dump truck according to claim 3, further comprising
a blower fan disposed inside the first duct.

6. The dump truck according to claim 3, further comprising
a blower fan disposed inside the motor housing.

7. The dump truck according to claim 5, wherein
the blower fan is rotated by the electric motor.

8. The dump truck according to claim 7, wherein
the blower fan includes a first blower fan rotated by the first electric motor and a second blower fan rotated by the second electric motor.

9. The dump truck according to claim 1, further comprising
a retarder brake; and
a second duct through which air supplied from the retarder brake to the internal flow path of the dump body flows.

10. The dump truck according to claim 9, further comprising
a brake housing that accommodates the retarder brake,
the second duct being disposed so as to connect the brake housing and a second inflow port of the internal flow path.

11. The dump truck according to claim 10, wherein
the second inflow port is provided in a front plate of the dump body.

12. The dump truck according to claim 9, further comprising
a first valve that opens and closes a flow path of the first duct,
the first valve opening the flow path of the first duct during traveling on an upward slope or a flat road, and closing the flow path of the first duct during traveling on a downward slope.

13. The dump truck according to claim 12, further comprising
an exhaust duct connected to the first duct; and
a second valve that opens and closes a flow path of the exhaust duct,
the second valve closing the flow path of the exhaust duct during traveling on an upward slope or a flat road, and opening the flow path of the second duct during traveling on a downward slope.

14. The dump truck according to claim 9, further comprising
a blower fan that rotates to supply air from the electric motor to the internal flow path of the dump body during traveling on an upward slope or a flat road; and
a retarder fan that rotates to supply air from the retarder brake to the internal flow path of the dump body during traveling on a downward slope.

15. The dump truck according to claim 9, further comprising
a blower fan that rotates to supply air from the electric motor to the internal flow path of the dump body;
a retarder fan that rotates to supply air from the retarder brake to the internal flow path of the dump body during traveling on a downward slope;
a first temperature sensor that detects a temperature around the electric motor; and
a second temperature sensor that detects a temperature around the retarder brake,
the blower fan rotating when a detection value of the first temperature sensor is equal to or more than a first predetermined value, and
the retarder fan rotating when a detection value of the second temperature sensor is equal to or more than a second predetermined value.

16. The dump truck according to claim 9, wherein
the internal flow path of the dump body includes a first internal flow path and a second internal flow path partitioned from the first internal flow path,
the first duct is connected to a first inflow port of the first internal flow path, and
the second duct is connected to a second inflow port of the second internal flow path.

17. The dump truck according to claim 16, wherein
the dump body includes a bottom plate, a front plate, a left plate, and a right plate,
at least a part of the first internal flow path is provided in a central portion of the bottom plate in a vehicle width direction, and
the second internal flow path is provided at each of a boundary portion between the bottom plate and the front plate, a boundary portion between the bottom plate and the left plate, and a boundary portion between the bottom plate and the right plate.

18. The dump truck according to claim 9, wherein
the supply of air from the electric motor to the internal flow path and the supply of air from the retarder brake to the internal flow path are switched between traveling on an upward slope and traveling on a downward slope,
air is supplied from the electric motor to the internal flow path during traveling on an upward slope, and
air is supplied from the retarder brake to the internal flow path during traveling on a downward slope.

19. A dump truck comprising:
a drive wheel;
a vehicle body supported by the drive wheel;
a dump body supported by the vehicle body;
an electric motor that rotates the drive wheel;
a first duct through which air supplied from the electric motor to an internal flow path of the dump body flows;
a blower fan that rotates to supply air from the electric motor to the internal flow path of the dump body; and
a first temperature sensor that detects a temperature around the electric motor,
the blower fan rotating when a detection value of the first temperature sensor is equal to or more than a first predetermined value.
